(19) United States
(12) Patent Application Publication
(10) Pub. No.: US 2008/0089533 A1
(43) Pub. Date: Apr. 17, 2008

(54) Circuit arrangement for suppression of switching noises

(75) Inventors: Ulrich Theus, Gundelfingen (DE); Juergen Kessel, Freiburg (DE)

Correspondence Address: Maginot, Moore & Beck, Chase Tower, 111 Monument Circle, Suite 3250, Indianapolis, IN, 46204, US

(73) Assignee: MICRONAS GmbH, Freiburg (DE)

(21) Appl. No.: 11/900,921

(22) Filed: Sep. 13, 2007

(30) Foreign Application Priority Data
Sep. 13, 2006 (DE) 10 2006 043 746.2

(51) Int. Cl. H04B 15/00

(52) U.S. Cl. 381/94.5

(57) ABSTRACT

An integrated audio amplifier includes an operation amplifier that includes a precharging device and a monitoring device. The operation amplifier further comprises an input stage and an output stage. The output stage includes a compensation capacitor. The precharging device is configured to precharge the compensation capacitor to a voltage that can be predetermined. The monitoring device detects a not-ready-for operation state of the audio amplifier and activates the precharging device, while at the same time, the output stage is blocked until such time as the compensation capacitor is charged by the precharging device to the predetermined voltage.

### FIELD OF THE INVENTION

The invention relates to an integrated audio amplifier in which the switching noises are suppressed.

### BACKGROUND

Integrated audio amplifiers have been known for a long time. An example in the CMOS technology is described for instance in EP 0 460 263 A1 filed by the present applicant.

A problem with integrated audio amplifiers is the fact that switching noises occur when they are switched on, in particular, cracking. This problem is usually solved at the device level of audio amplifiers by providing a relay in the speaker line, which delays the switching on of the speaker. This solution, however, is not suitable for integration.

From DE 195 03 881 A1 is known a mute switch for an audio amplifier. This mute switch device in this case is arranged at the output of the audio amplifier and is used for suppression of the switch interference voltage in the output signal. This mute switch device contains a bipolar transistor, which is used as a short-circuiting switch for the impulse interference voltage and is arranged without initial bias voltage parallel to the audio output.

### SUMMARY

An object of at least some embodiments is to provide an integrated audio amplifier in which such switching noise is effectively suppressed, so that the integrated switch of the audio amplifier is adjusted in a suitable manner for this purpose.

This goal is achieved with an integrated audio amplifier according to at least some embodiments of the invention.

Further embodiments of such an integrated audio amplifier are the subject of the dependent claims.

The integrated audio amplifier according to the invention is provided essentially with the following characteristics aimed at suppression of noise during activation:

an operation amplifier,

the operation amplifier provided with an input stage and an output stage

the output state having a compensation capacitor, which is linked to the input and output of the output state,

a precharging device for charging of the compensation capacitor to a predetermined voltage, and

a monitoring device, through which the switching of an audio amplifier is detected and the precharging device is activated so that the output stage is blocked until such time as the compensation capacitance has been charged by the precharging device up to a predetermined voltage.

The invention therefore preferably based on operation amplifier circuits having a negative resistance feedback, which are operated with simple operating voltage. This means that the operation amplifier is supplied by being connected to a positive operating potential and ground potential.

In conventional operation amplifiers or audio amplifiers, all voltages are in the turned off status, that is to say, with the operating voltage turned off, at the potential of the negative operating voltage or of the ground potential, and the standby currents are at zero. In particular, both the output of the operation amplifier and also the internal connection between the input stage and the output stage are in the switched off state at the potential of the negative operation voltage, i.e. at the reference potential, as long as the negative operating voltage is ground potential. In the switched on state of the operation amplifier or of the audio amplifier, the voltage in the internal connection between the input state and the output stage is at least 0.5 V, when the output is at the potential of the negative operating voltage.

During the transition from the turned off state to the turned on state, the common mode voltage is slowly being increased at the inputs together with the output voltage until about half of the level of the operating voltage is reached. In such a case, the amplifier is first in a non-operating state. The ready-for-operation state is achieved only after a certain time period, which is relatively short. At the same time, the standby current is increased in all of the stages in the operation amplifier proportionally to a reference voltage, which is also increased from zero to the relevant nominal value. According to prior art, the transition from the switched off state to the switched on state is carried out so that the voltage at the connection nodes between the input stage and the output stage has priority, which means that it is raised immediately to its operative value. Provided that a compensation condenser is deployed between the input and the output of the output stage of the operation amplifier which is not yet charged, the output of the operation amplifier is also increased. Due to the large differential voltage at the input, the tail current of the input stage is supplied to the compensation condenser and the condenser is charged by this voltage.

In this case, the output voltage is gradually brought back to the potential of the negative operating voltage. This operation can be distinctly heard as a cracking sound which is heard when the integrated audio amplifier is turned on.

With the solution provided by the integrated audio amplifier according to the invention, the non-operational state of the potential is detected at the connection nodes between the input stage and the output stage. The “normal” function of the output stage is blocked and a current is supplied by the compensation condenser so that the condenser is charged to a predetermined voltage which approximately corresponds to the operative voltage. When this is achieved, the “normal function” of the output stage is released.

With the development of the integrated audio amplifier according to the invention, the voltage impulse at the output of the operation amplifier can be reduced from about 500 mV to about 25 mV, and the voltage impulse interval can thus be reduced over time. Undesirable cracking of activation noise thus becomes inaudible or barely audible.

### BRIEF DESCRIPTION OF THE DRAWINGS

An embodiment example of an integrated audio amplifier will now be explained in more detail based on the reference provided in the figures:

FIG. 1 shows a diagram of the main block of the integrated audio amplifier according to the invention, and

FIG. 2 shows an exemplary embodiment example of an integrated audio amplifier which can be used to efficiently suppress activation noise.

### DETAILED DESCRIPTION

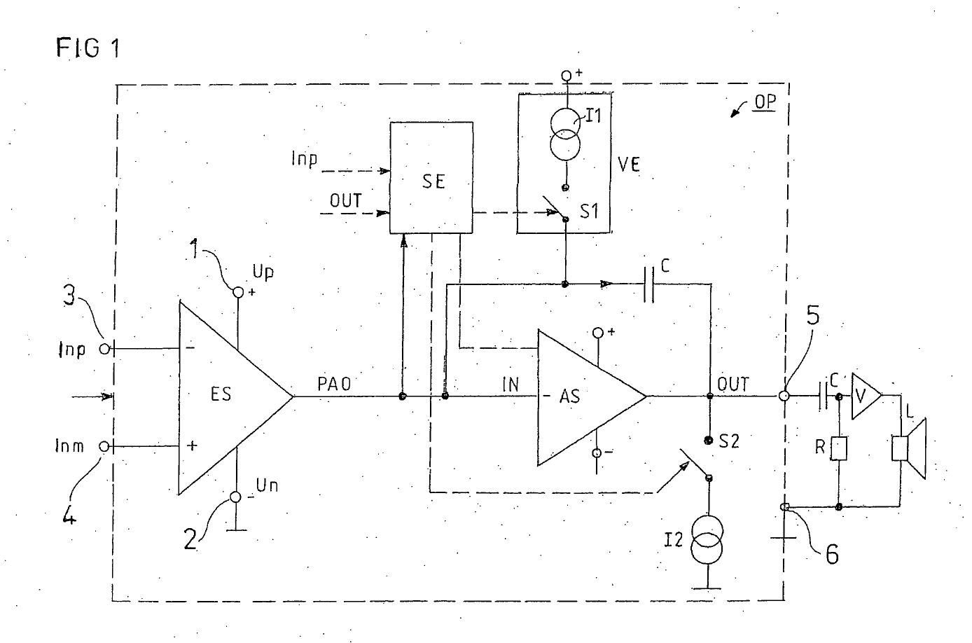

FIG. 1 depicts a circuit diagram of the main circuit of an integrated audio amplifier, shown in a simplified form.

The integrated audio amplifier is equipped with an operational amplifier OP which has an input stage ES and an output stage AS. The input stage ES is connected to a first supply terminal and to a second supply terminal 2. A positive operating potential Up is input to the first supply terminal 1 and a negative supply operating potential Uₙ is input to the second supply terminal. The negative supply terminal Uₙ is in the embodiment example the ground potential. The input stage ES is a conventional differential stage, which is provided with two input terminals 3, 4. The input terminal 3 is connected to the negative input and the input terminal 4 is connected to the positive input of the input stage ES. A differential input signal is input at both input terminals 3, 4 so that a first input signal Inp is input at the input terminal 3, and a second input signal Inm is input at the second input source 4. The output PAO of the input stage ES is connected by being electrically coupled to the input IN of the output stage AS, for instance, directly. The output OUT of the output stage AS is connected to the output terminal 5 of the operation amplifier. Another output terminal 6 of the operation amplifier OP is deployed at the ground potential. At both of these output terminals 5, 6 of the integrated audio amplifier can be connected a speaker arrangement L, an amplifier V, a resistance R and a blocking condenser (blocking capacitor) C as discrete structural elements. In a manner which is customary in operation amplifiers, the input IN and the output OUT of the output stage AS are bridged over with a compensation capacitor C. Up until this point, a conventional operation amplifier OP was described, which is employed as an audio amplifier.

A problem with such an integrated audio amplifier is the fact that when the audio amplifier is turned on, or when the operation of the audio amplifier is started, a distinct starting noise can be heard, in particular cracking, in the speaker L. These activation noises can be significantly reduced with the measures described below. The integrated audio amplifier is in this case expanded by a monitoring device SE and a precharging device VE. The precharging device VE is provided with a positive operating potential VE supplied from a connected current source I1, which is connected to a terminal of the compensation capacitor C by a switch S1 at the input of the output stage AS. The switch S1 can be connected to and disconnected by the monitoring device SE. In addition, another current source I2 can be controlled with another series switch S2 by the monitoring device SE. This additional switch S2 and the current source I2 are deployed between the output OUT of the output stage AS and the output terminal 6. The monitoring device SE performs monitoring to determine whether the integrated audio amplifier is turned on. In the embodiment example of FIG. 1, the signal of the input stage ES, which is input at the output PAO, is tapped and supplied to the monitoring device SE. The signals Inp and OUT could be supplied to the monitoring device SE as control signals as shown in FIG. 1.

During “normal” operation, both switches S1 and S2 are off. On the other hand, in the switched off state of the audio amplifier, all the voltages are at the potential of the negative operating voltage, that is to say at the ground potential, and the standby currents are therefore at zero. In particular, in the switched off state, both the output OUT of the entire audio amplifier and the output PAO of the input stage ES are at the potential of the negative operating voltage.

In the switched on state or the ready-for-operation state, the output PAO of the input stage ES is for example at about 0.5 V, so that the output OUT is still at the potential of the negative operating voltage. If the compensation condenser C is not yet charged, the output signal OUT will also be increased very quickly with this value. After that, the output voltage falls gradually back again to the potential of the negative operating voltage, specifically as long as the compensation capacitance is being charged, namely with the current that is supplied from the input stage ES.

This status is detected by the arrangement according to the invention shown in FIG. 1, as the monitoring device SE taps the signal at the output PAO of the input stage ES. When after the activation of the audio amplifier, the potential at the output PAO is significantly lower than the mentioned value of at least 0.5 V, the monitoring device SE ensures that the switch S2 is closed during this time and the switch S1 is also closed. With the simultaneous closing of the switch S1, a current is I1 is supplied from the current source I1 of the precharging device VE through the compensation condenser C until it is charged to a predetermined voltage, and the current is conducted away through the switch S2 as current I2. It is advantageous in such a case when the current I1 equals the current I2. This predetermined voltage can be, for example, an operating voltage. Only when the compensation condenser C is charged to this predetermined voltage is the normal function of the output stage AS released, wherein the switches S1 and S2 are again opened. The voltage impulse at the output OUT is thus reduced from about 500 mV to about 25 mV. This voltage pulse is thus practically no longer audible.

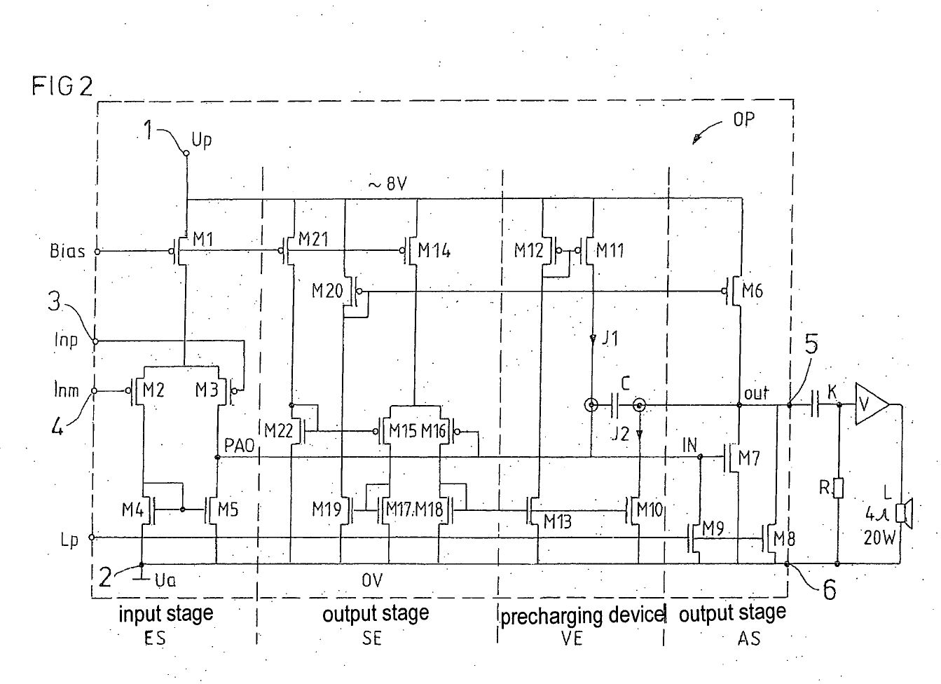

A detailed example of an integrated audio amplifier realized in CMOS technology will now be explained with reference to FIG. 2.

Similarly to the arrangement shown in FIG. 1, the operation amplifier OP depicted in FIG. 2 is provided with an input stage ES, a monitoring device SE, a precharging device VE, and an output stage AS. The integrated switching circuit is equipped with two supply terminals 1, 2. The first supply terminal 1 is connected to the positive operating potential Uₚ, and the second supply terminal 2 is connected to the negative operating terminal Uₙ, providing a ground potential. In the manner previously explained, two input terminals 3, 4 are provided to which the input signals Inp and Inm are input. Both output terminals 5, 6 are deployed at the output side.

The input stage ES is equipped with an input current source connected in series having a p-channel transistor M1, which is connected to the supply terminal 1, and with a p-channel differential stage having p-channel transistors M2 and M3. The control terminal of the p-channel transistor M2 is connected to the input terminal 4, and the control terminal of the p-channel transistor M3 is connected to the input terminal 3. Both p-channel transistors M2 and M3 are connected through an n-channel current mirror to the n-channel transistors M4 and M5 and to the second supply terminal 2. In this case, the input of these n-channel current mirrors is connected to the p-channel transistor M2 and the output of the n-channel current mirror is connected to the output PAO. The control terminal of the first transistor M1 is connected to the terminal Bias to which an auxiliary potential is input. The connection point between the transistor M3 of the p-channel differential stage and the transistor M5 of the n-channel current mirror is the output PAO of the input stage ES.

The output stage AS of the integrated audio amplifier is equipped essentially with the load lines of a p-channel transistor M6 provided with an n-channel transistor M7, which are connected in series between the terminal 1 and 2. The control terminal of the n-channel transistor M7 is connected to the input IN of the output stage AS, and at the same time also with the output PAO of the input stage ES. The output of the output state AS, and therefore the output of the integrated amplifier, indicated by the word out, is at the same time the connection point of the transistor M6 and of the transistor M7. This output OUT is connected to the first output terminal 5. The second output terminal 6 is located at the ground terminal and is therefore in contact with the second supply terminal 2. In addition, the output stage is also equipped with the compensation capacitor C, which is connected between the input IN and the output out of the output stage AS.

Another n-channel transistor M8 has its load path connected between both output terminals 5, 6. The ninth n-channel transistor M9 is connected between the input IN of the output stage AS and the output terminal 6. The control terminals of both of these transistors M8 and M9 are connected to a terminal on the input side that can be provided with a standby signal, so that an auxiliary signal can thus be input in order to deactivate the output stage AS.

The construction of the controlled current source, known from FIG. 1, includes an n-channel transistor M10, shown in the circuit arrangement of FIG. 2, which is used as a current source and has its load path connected between the output OUT of the output stage AS and the output terminal 7.

The N-channel transistor M10 supplies the current known from FIG. 1.

The precharging device VE is equipped with a current mirror having the p-channel transistors M11 and 12. Connections to both p-channel transistors M11 and M12 are in contact with the supply terminal 1. The input of the current mirror, that is to say the other free input of the transistor M12, is connected through the load path of another n-channel transistor M13 to the second supply terminal 2. The output of the current mirror, that is to say the other free connection of the p-channel transistor M11, is connected to both terminals PAO of the input stage ES and with the input terminal IN of the output stage AS. At this output of the current mirror can be tapped the current I1 explained above in connection with FIG. 1.

The monitoring device VE is equipped with another current source in the form of the p-channel transistor M14, which is connected to the supply terminal 1. The other connection of the load path p-channel transistor M14 is connected to the second supply terminal 2 through a p-channel differential stage comprising the transistors M15, M16, and via respective diode-connected n-channel transistors M17 and M18. The control terminal of the p-channel transistor M15 is provided with a predetermined potential in a manner yet to be explained.

The control terminal n-channel transistor M17 is connected to the control terminal of another n-channel transistor M19. The load path of this other transistor M19 is on the one hand connected to the second supply terminal 2, and the other hand through a p-channel transistor M20 to the first supply terminal 1.

The connection point between the transistors M19 and M20 is connected to the control terminal of the p-channel transistor M20 and to the control terminal of the p-channel transistor M6 of the output stage AS. A current mirror is thus formed by the p-channel transistors M6 and M20. The control terminal M18 is connected to the control terminals of the transistors M10 and M13. Finally, the circuit arrangement of FIG. 2 is also equipped with another current source in the form of a p-channel transistor M21, which is connected through a terminal of its load path to the supply terminal 1 and through the other terminal of the load path to the supply terminal 2 through the load path of a transistor M22. The control terminal of the p-channel transistor M21 is—similarly to the control terminal of the p-channel transistor M14—connected to the terminal bias. The control terminal of the transistor M22 is in contact with the control terminal of the transistor M15 and with the connection point of the load path of the transistors M21 and M22.

The serial arrangement of a blocking condenser K, an amplifier V and a speaker L, are connected between the output terminals 5, 6 of the integrated audio amplifier. In addition, a resistor R is connected between the connection point of the blocking condenser K and the amplifier V and the output terminal 6 of the output stage AS. The functional operation of the integrated circuit arrangement depicted in FIG. 2 is as follows:

The monitoring device SE detects the particular state when the system is turned on and applies appropriate control to the precharging device VE and to the output stage AS. The transistors M21 and M22 are dimensioned in such a way that the gate source voltage of the n-channel transistor M22 is smaller than the operating voltage at the output PAO of the input stage ES. In this manner, the current is supplied during normal operations from the p-channel transistor M14 through the transistors M15, M17 and M19, as well as M20 for the standby current of the output stage AS. During the transition from the no-current state to the active state, the potential at the output PAO of the input stage ES is at first still at 0 V. The current from the transistor M14 is in this case supplied via the transistors M16 and M18 in the precharging device VE. The precharging device VE sends this current by means of the transistors M13, M12 and M11 into the compensation condenser C, from which the current is discharged through the transistor M10.

When the voltage has reached the gate source voltage level at the transistor M22 through the compensation condenser C, this precharging operation of the compensation capacitor C is finished, and the circuit switches over to normal operations, without creating a substantial voltage peak at that output OUT.

The cracking sounds occurring when the device is turned on can thus be reduced with a similar arrangement by about 26 dB.

The integrated audio amplifier according to the invention can be employed in all audio output stages of the line-out type, which are connected to the end amplifier without an interposed speaker control.
1 supply terminal
2 supply terminal
3 input terminal
4 input terminal
5 output terminal
6 output terminal
AS output stage
BIAS auxiliary potential
C compensation capacitor
ES input stage
I1 current in the compensation capacitor
I2 current from the compensation capacitor
Inp input signal at the first input terminal 3 of the input stage ES
Inm input signal at the second input source 4 of the input stage ES
K coupling capacitor
L speaker
Lp switching signal
M1 first transistor
M2 second transistor
M3 third transistor
M4 fourth transistor
M5 fifth transistor
M6 sixth transistor
M7 seventh transistor
M8 eighth transistor
M9 ninth transistor
M19 tenth transistor
M11 eleventh transistor
M12 twelfth transistor
M13 thirteenth transistor
M14 fourteenth transistor
M15 fifteenth transistor
M16 sixteenth transistor
M17 seventeenth transistor
M18 eighteenth transistor
M19 nineteenth transistor
M20 twentieth transistor
M21 twenty first transistor
M22 twenty second transistor
OP operation amplifier
OUT output signal of output stage AS
Uₙ negative supply potential
Uₚ positive supply potential
SE detection device
V external amplifier
VE precharging device
I current source
S1 switch
S2 switch
Lp standby control signal
R resistor

What is claimed is:

1. An integrated audio amplifier arrangement having suppression of switching noise, the arrangement comprising:
an operational amplifier, the operational amplifier having an input stage, an output stage, a precharging device, and a monitoring device, the output stage including a compensation capacitor, the precharging device configured to precharge of the compensation capacitor to a voltage that can be predetermined, and the monitoring device configured to detect an operational state in which the audio amplifier is not ready for operation and to activate precharging device, the monitoring device further configured to block the output stage until such time as the compensation capacitor is charged by the precharging device to the predetermined voltage.

2. The integrated audio amplifier arrangement according to claim 1, wherein the arrangement is realized with CMOS technology.

3. The integrated audio amplifier arrangement according to claim 1, wherein the input stage is designed as a differential amplifier.

4. The integrated audio amplifier arrangement according to claim 3, wherein the differential amplifier of the input stage includes a series circuit having an input current source comprising a first transistor, a differential stage having a second transistor and a third transistor, and a current mirror having a fourth transistor and a fifth transistor, wherein the series circuit is connected between two supply terminals, and wherein the supply terminals are configured to receive first and second supply potentials.

5. The integrated audio amplifier arrangement according to claim 4, further comprising two input terminals connected to the second transistor and the third transistor for the input of an input differential voltage.

6. The integrated audio amplifier arrangement according to claim 1, wherein the audio amplifier includes two output terminals, and wherein a first of the output terminals is connected to one of two supply terminals.

7. The integrated audio amplifier arrangement according to claim 6, further comprising an external audio stage having a speaker connected between the output terminals.

8. The integrated audio amplifier arrangement according to claim 5, wherein the output stage of the integrated audio amplifier includes a series circuit having a sixth transistor and a seventh transistor, wherein the series circuit is connected between the supply terminals, and wherein a connection point of the sixth transistor and the seventh transistor is connected to one of two output terminals.

9. The integrated audio amplifier arrangement according claim 1, wherein the compensation capacitor is connected between an input and an output of the output stage.

10. The integrated audio amplifier arrangement according to claim 9, wherein an effective control voltage of the output stage can be tapped between the input and the output.

11. The integrated audio amplifier arrangement according to claim 1, wherein the compensation capacitor is connected to the input of the output stage at an output (PAO) of the input stage, and wherein an input current in the compensation capacitor corresponds to an output current from the compensation capacitor.

12. The integrated audio amplifier arrangement according to claim 8, wherein the precharging device includes an eighth transistor, the eighth transistor configured as a current source and connected between two output terminals of the output stage.

13. The integrated audio amplifier arrangement according to claim 12, wherein the precharging device (VE) includes a current mirror having a ninth transistor (M11) and a tenth transistor (M12), the current mirror connected to a positive potential (Uₚ) of one of the supply terminals, on a current mirror input side through an eleventh transistor to the other supply terminal, and on a current mirror output side to the connection terminal of the compensation capacitor, the compensation capacitor connected to the input of the output stage at the output of the input stage.

14. The integrated audio amplifier arrangement according to claim 13, wherein the eighth transistor and the eleventh transistor are provided, respectively, with the control connections which are connected to an output of the monitoring device.

15. The integrated audio amplifier arrangement according to claim 14, wherein the monitoring device includes a twelfth transistor configured as a current source in series with another differential stage, the other differential stage including a thirteenth transistor and a fourteenth transistor, and that the thirteenth transistor and the fourteenth transistor are connected through the fifteenth transistor and a sixteenth transistor to one of the supply terminals which is connected to a negative supply potential.

16. The integrated audio amplifier according to claim 15, wherein the monitoring device includes a series circuit having load paths of a seventeenth transistor and an eighteenth transistor, wherein the series circuit is connected between the supply terminals, and a control connection of the seventeenth transistor is connected to a control connection of the fifteenth transistor, and a control connection of the eighteenth transistor is connected to a control connection of the sixth transistor of the output stage and also to the seventeenth transistor.
